(19) United States
(12) Patent Application Publication
(10) Pub. No.: US 2006/0269859 A1
(43) Pub. Date: Nov. 30, 2006

(54) Emulsion aggregation toner and developer

(75) Inventors: Vladislav Skorokhod, Mississauga (CA); Richard P.N. Veregin, Mississauga (CA); Wafa F. Bashir, Mississauga (CA); Paul J. Gerroir, Oakville (CA); Emily L. Moore, Mississauga (CA)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/139,649

(22) Filed: May 31, 2005

(51) Int. Cl. G03G 9/08; G03G 15/14

(52) U.S. Cl. 430/108.3; 430/126; 430/109.3; 430/110.2; 430/108.6; 430/137.14

(57) ABSTRACT

A toner that is emulsion aggregation toner particles having an acrylate-containing polymer binder and at least one colorant has an average particle size of from about 5.0 μm to about 6.7 μm and an average circularity of about 0.950 to about 0.970. The toner preferably is comprised of styrene-butyl acrylate binder and gel. The toner preferably exhibits a transfer efficiency of about 0.8-1.0, a developability of about 0.3 to about 1.5 mg/cm², and a charge to diameter ratio (q/d) of about −0.7 to about −0.1 fC/micron. A developer containing the toner and a method of forming an image using the toner are also described.

### BACKGROUND

Described herein are toners, and developers containing the toners, for use in forming and developing images of good quality and gloss, and in particular to a toner having a novel combination of properties ideally suited for use in image forming devices utilizing hybrid jumping development systems.

Emulsion aggregation toners are excellent toners to use in forming print and/or xerographic images in that the toners can be made to have uniform sizes and in that the toners are environmentally friendly. U.S. patents describing emulsion aggregation toners include, for example, U.S. Pat. Nos. 5,370,963, 5,418,108, 5,290,654, 5,278,020, 5,308,734, 5,344,738, 5,403,693, 5,364,729, 5,346,797, 5,348,832, 5,405,728, 5,366,841, 5,496,676, 5,527,658, 5,585,215, 5,650,255, 5,650,256, 5,501,935, 5,723,253, 5,744,520, 5,763,133, 5,766,818, 5,747,215, 5,827,633, 5,853,944, 5,804,349, 5,840,462, and 5,869,215, each incorporated herein by reference in its entirety.

One main type of emulsion aggregation toner include emulsion aggregation toners that are acrylate based, e.g., styrene acrylate toner particles. See, for example, U.S. Pat. No. 6,120,967, incorporated herein by reference in its entirety, as one example.

Emulsion aggregation techniques typically involve the formation of an emulsion latex of the resin particles, which particles have a small size of from, for example, about 5 to about 500 nanometers in diameter, by heating the resin, optionally with solvent if needed, in water, or by making a latex in water using emulsion polymerization. A colorant dispersion, for example of a pigment dispersed in water, optionally also with additional resin, is separately formed. The colorant dispersion is added to the emulsion latex mixture, and an aggregating agent or complexing agent is then added to form aggregated toner particles. The aggregated toner particles are optionally heated to enable coalescence/fusing, thereby achieving aggregated, fused toner particles.

U.S. Pat. No. 5,462,828 describes a toner composition that includes a styrene/n-butyl acrylate copolymer resin having a number average molecular weight of less than about 5,000, a weight average molecular weight of from about 10,000 to about 40,000 and a molecular weight distribution of greater than 6 that provides excellent gloss and high fix properties at a low fusing temperature.

What is still desired is a styrene acrylate emulsion aggregation toner that can achieve excellent print quality, particularly for use in hybrid jumping development image forming systems.

### SUMMARY

In embodiments, described is a toner comprising emulsion aggregation toner particles comprising a binder, comprised of an acrylate-containing polymer, and at least one colorant, wherein the toner particles have an average particle size of from about 5.0 μm to about 6.7 μm and an average circularity of about 0.950 to about 0.970. Preferably, the acrylate-containing polymer is a styrene-butyl acrylate.

In further embodiments, the toner includes a highly crosslinked gel in the binder. The toner may also include a shell layer, preferably comprised of the same polymer as the binder.

In still further embodiments, described is a toner wherein the toner particles exhibit a transfer efficiency of about 0.8-1.0, a developability of about 0.3 to about 1.5 mg/cm², and a mean charge to diameter ratio (q/d) of about −0.7 to about −0.1 femto-Coulombs per micron.

In still further embodiments, described is a developer comprising a toner comprising emulsion aggregation toner particles comprising a binder, comprised of an acrylate-containing polymer, and at least one colorant, wherein the toner particles have an average particle size of from about 5.0 μm to about 6.7 μm and an average circularity of about 0.950 to about 0.970, and carrier particles.

In still further embodiments, described is a method of forming an image with toner, comprising charging the toner, applying the charged toner to a biased donor member such as donor roll, moving the toner from the donor to an oppositely charged latent image on an imaging member to develop the image, and transferring the developed image to an image receiving substrate, wherein the toner comprises emulsion aggregation toner particles comprising a binder, comprised of an acrylate-containing polymer, and at least one colorant, wherein the toner particles have an average particle size of from about 5.0 μm to about 6.7 μm and an average circularity of about 0.950 to about 0.970.

### BRIEF DESCRIPTION OF THE DRAWINGS

FIG. 1 summarizes the developability for each of four example toners.

FIG. 2 summarizes the transfer efficiency for each of the four example toners.

FIG. 3 summarizes the charge (q/d) for each of the four example toners.

### DETAILED DESCRIPTION OF EMBODIMENTS

In embodiments, the toner particles are made to have an average particle size of from about 5.0 to about 6.7 μm and an average circularity of about 0.950 to about 0.970. The particle size may be determined using any suitable device, for example a conventional Coulter counter. The circularity may be determined using the known Malvern Sysmex Flow Particle Image Analyzer FPIA-2100. The circularity is a measure of the particles closeness to a perfect sphere. A circularity of 1.0 identifies a particle having the shape of a perfect circular sphere.

The toner particles cohesivity is associated to some degree with the surface morphology of the particles. The rounder/smoother the surface of the particles, the lower the cohesion and the greater the flow. As the surface becomes less round/rougher, the flow worsens and the cohesion increases.

The toner particles also preferably have a size such that the upper geometric standard deviation (GSD) by volume for (D84/D50) is in the range of from about 1.15 to about 1.25. The particle diameters at which a cumulative percentage of 50% of the total toner particles are attained are defined as volume D50, and the particle diameters at which a cumulative percentage of 84% are attained are defined as volume D84. These aforementioned volume average particle size distribution indexes GSDv can be expressed by using D50 and D84 in cumulative distribution, wherein the volume average particle size distribution index GSDv is expressed as (volume D84/volume D50). The upper GSDv value for the toner particles indicates that the toner particles are made to have a very narrow particle size distribution.

It may also be desirable to control the toner particle size and limit the amount of both fine and coarse toner particles in the toner. The toner particles may have a very narrow particle size distribution with a lower number ratio geometric standard deviation (GSDn) of from about 1.20 to about 1.30.

The toner particles described herein are comprised of polymer binder and a colorant. A wax is also preferably included in the toner particles.

Illustrative examples of specific polymer resins for the binder, mention may be made of acrylate containing polymers, for example, poly(styrene-alkyl acrylate), poly(styrene-alkyl methacrylate), poly(styrene-alkyl acrylate-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(alkyl acrylate-acrylonitrile-acrylic acid), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene),-poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and other similar polymers.

Preferably, the binder is comprised of a styrene-alkyl acrylate. More preferably, the styrene-alkyl acrylate is a styrene-butyl acrylate copolymer resin, and most preferably, a styrene-butyl acrylate β-carboxyethyl acrylate polymer resin.

The monomers used in making the polymer binder are not limited, and the monomers utilized may include any one or more of, for example, styrene, acrylates such as methacrylates, butylacrylates, β-carboxyethyl acrylate (β-CEA), etc., butadiene, isoprene, acrylic acid, methacrylic acid, itaconic acid, acrylonitrile, benzenes such as divinylbenzene, etc., and the like. Known chain transfer agents can be utilized to control the molecular weight properties of the polymer. Examples of chain transfer agents include dodecanethiol, dodecylmercaptan, octanethiol, carbon tetrabromide, carbon tetrachloride, and the like in various suitable amounts, for example of about 0.1 to about 10 percent by weight of monomer, and preferably of about 0.2 to about 5 percent by weight of monomer. Also, crosslinking agents such as decanedioldiacrylate or divinyl benzene may be included in the monomer system in order to obtain higher molecular weight polymers, for example in an effective amount of about 0.01 percent by weight to about 25 percent by weight, preferably of about 0.5 to about 10 percent by weight.

In a preferred embodiment, the monomer components, with any of the aforementioned optional additives, are preferably formed into a latex emulsion and then polymerized to form small sized polymer particles, for example on the order of about 5 nm to about 500 nm. The monomers and agents may be formed into a latex emulsion with or without the use of suitable surfactants, as necessary. Of course, any other suitable method for forming the latex polymer particles from the monomers may be used without restriction.

In a preferred embodiment, the binder is comprised of a mixture of two binder materials of differing molecular weights, such that the binder has a bimodal molecular weight distribution (i.e., molecular weight peaks at least at two different molecular weight regions). For example, in one preferred embodiment, the binder is comprised of a first lower molecular weight binder and a second high molecular weight binder. The first binder preferably has a number average molecular weight (Mn), as measured by gel permeation chromatography (GPC), of from, for example, about 1,000 to about 30,000, and more specifically from about 5,000 to about 15,000, a weight average molecular weight (Mw) of from, for example, about 1,000 to about 75,000, and more specifically from about 25,000 to about 40,000, and a glass transition temperature of from, for example, about 40° C. to about 75° C. The second binder preferably has a substantially greater number average and weight average molecular weight, for example over 1,000,000 for Mw and Mn, and a glass transition temperature of from, for example, about 35° C. to about 75° C. The glass transition temperature may be controlled, for example by adjusting the amount acrylate in the binder. For example, a higher acrylate content can reduce the glass transition temperature of the binder. The second binder may be referred to as a gel, i.e., a highly crosslinked polymer, due to the extensive gelation and high molecular weight of the latex. In this embodiment, the gel binder may be present in an amount of from about 0% to about 50% by weight of the total binder, preferably from about 8% to about 35% by weight of the total binder.

The gel portion of the binder distributed throughout the first binder affects the gloss properties of the toner, in particular by reducing gloss.

The first, lower molecular weight binder may be selected from among any of the aforementioned polymer binder materials. The second gel binder may be the same as or different from the first binder. For example, the second gel binder may be comprised of highly crosslinked materials such as poly(styrene-alkyl acrylate), poly(styrene-butadiene), poly(styrene-isoprene), poly(styrene-alkyl methacrylate), poly(styrene-alkyl acrylate-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrileacrylic acid), and poly(alkyl acrylate-acrylonitrile-acrylic acid), and/or mixtures thereof. In a preferred embodiment, the gel binder is the same as the first binder, and both are a styrene acrylate, preferably styrene-butyl acrylate. The higher molecular weight of the second gel binder may be achieved by, for example, including greater amounts of styrene in the monomer system, including greater amounts of crosslinking agent in the monomer system and/or including lesser amounts of chain transfer agents.

Preferably, the gel latex comprises submicron crosslinked resin particles of about 10 to about 400 nanometers, more preferably about 20 to about 250 nanometers, suspended in an aqueous water phase containing a surfactant.

In a still further preferred embodiment, the toner particles have a core-shell structure. In this embodiment, the core is comprised of the toner particle materials discussed above, including at least the binder and the colorant. Once the core particle is formed and aggregated to a desired size, a thin outer shell is then formed upon the core particle. The shell is preferably comprised of only binder material, although other components may be included therein if desired.

The shell is preferably comprised of a latex resin that is the same as a latex of the core particle. Although the shell latex may be comprised of any of the polymers identified above, it is preferably a styrene acrylate polymer, most preferably a styrene-butyl acrylate polymer. The shell latex may be added to the toner aggregates in an amount of about 5 to about 40 percent by weight of the total binder materials, and preferably in an amount of about 5 to about 30 percent by weight of the total binder materials. Preferably, the shell or coating on the toner aggregates has a thickness wherein the thickness of the shell is about 0.2 to about 1.5 μm, preferably about 0.5 to about 1.0 μm.

The total amount of binder, including core and shell if present, is preferably an amount of from about 60 to about 95% by weight of the toner particles (i.e., toner particles exclusive of external additives) on a solids basis, preferably from about 70 to about 90% by weight of the toner.

Various suitable colorants can be employed, including suitable colored pigments, dyes, and mixtures thereof. Suitable examples include, for example, carbon black such as REGAL 330 carbon black, acetylene black, lamp black, aniline black, Chrome Yellow, Zinc Yellow, SICOFAST Yellow, SUNBRITE Yellow, LUNA Yellow, NOVAPERM Yellow, Chrome Orange, BAYPLAST Orange, Cadmium Red, LITHOL Scarlet, HOSTAPERM Red, FANAL PINK, HOSTAPERM Pink, LUPRETON Pink, LITHOL Red, RHODAMINE Lake B, Brilliant Carmine, HELIOGEN Blue, HOSTAPERM Blue, NEOPAN Blue, PV Fast Blue, CINQUASSI Green, HOSTAPERM Green, titanium dioxide, cobalt, nickel, iron powder, SICOPUR 4068 FF, and iron oxides such as MAPICO Black (Columbia) NP608 and NP604 (Northern Pigment), BAYFERROX 8610 (Bayer), M08699 (Mobay), TMB-100 (Magnox), mixtures thereof and the like.

The colorant, preferably carbon black, cyan, magenta and/or yellow colorant, is incorporated in an amount sufficient to impart the desired color to the toner. In general, pigment or dye is employed in an amount ranging from about 2% to about 35% by weight of the toner particles on a solids basis, preferably from about 4% to about 25% by weight and more preferably from about 4% to about 15% by weight of the toner particles on a solids basis. Of course, as the colorants for each color are different, the amount of colorant present in each type of color toner typically is different.

In addition to the latex polymer binder and the colorant, the toners also preferably contain a wax dispersion. The wax is added to the toner formulation in order to aid toner offset resistance, e.g., toner release from the fuser roll, particularly in low oil or oil-less fuser designs. For emulsion aggregation (EA) toners, for example styrene-acrylate EA toners, linear polyethylene waxes such as the POLYWAX® line of waxes available from Baker Petrolite are useful. Of course, the wax dispersion may also comprise polypropylene waxes, other waxes known in the art, and mixtures of waxes.

To incorporate the wax into the toner, it is preferable for the wax to be in the form of an aqueous emulsion or dispersion of solid wax in water, where the solid wax particle size is usually in the range of from about 100 to about 500 nm.

The toners may contain from, for example, about 5 to about 15% by weight of the toner, on a solids basis, of the wax. Preferably, the toners contain from about 8 to about 12% by weight of the wax.

In addition, the toners of the-invention may also optionally contain a coagulant and a flow agent such as colloidal silica. Suitable optional coagulants include any coagulant known or used in the art, including the well known coagulants polyaluminum chloride (PAC) and/or polyaluminum sulfosilicate (PASS). A preferred coagulant is polyaluminum chloride. The coagulant is present in the toner particles, exclusive of external additives and on a dry weight basis, in amounts of from 0 to about 3% by weight of the toner particles, preferably from about greater than 0 to about 2% by weight of the toner particles. The flow agent, if present, may be any colloidal silica such as SNOWTEX OL/OS colloidal silica. The colloidal silica is present in the toner particles, exclusive of external additives and on a dry weight basis, in amounts of from 0 to about 15% by weight of the toner particles, preferably from about greater than 0 to about 10% by weight of the toner particles.

The toner may also include additional known positive or negative charge additives in effective suitable amounts of, for example, from about 0.1 to about 5 weight percent of the toner, such as quaternary ammonium compounds inclusive of alkyl pyridinium halides, bisulfates, organic sulfate and sulfonate compositions such as disclosed in U.S. Pat. No. 4,338,390, cetyl pyridinium tetrafluoroborates, distearyl dimethyl ammonium methyl sulfate, aluminum salts or complexes, and the like.

Also, in preparing the toner by the emulsion aggregation procedure, one or more surfactants may be used in the process. Suitable surfactants include anionic, cationic and nonionic surfactants.

Anionic surfactants include sodium dodecylsulfate (SDS), sodium dodecyl benzene sulfonate, sodium dodecylnaphthalene sulfate, dialkyl benzenealkyl, sulfates and sulfonates, abitic acid, the DOWFAX brand of anionic surfactants, and the NEOGEN brand of anionic surfactants. An example of a preferred anionic surfactant is NEOGEN RK available from Daiichi Kogyo Seiyaku Co. Ltd., which consists primarily of branched sodium dodecyl benzene sulphonate.

Examples of cationic surfactants include dialkyl benzene alkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecyl benzyl triethyl ammonium chloride, MIRAPOL and ALKAQUAT available from Alkaril Chemical Company, SANISOL (benzalkonium chloride), available from Kao Chemicals, and the like. An example of a preferred cationic surfactant is SANISOL B-50 available from Kao Corp., which consists primarily of benzyl dimethyl alkonium chloride.

Examples of nonionic surfactants include polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenc Inc. as IGEPAL CA-210, IGEPAL CA-520, IGEPAL CA-720, IGEPAL CO-890, IGEPAL CO-720, IGEPAL CO-290, IGEPAL CA-210, ANTAROX 890 and ANTAROX 897. An example of a preferred nonionic surfactant is ANTAROX 897 available from Rhone-Poulenc Inc., which consists primarily of alkyl phenol ethoxylate.

Any suitable emulsion aggregation procedure may be used in forming the emulsion aggregation toner particles without restriction. These procedures typically include the basic process steps of at least aggregating a latex emulsion containing binder, one or more colorants, optionally one or more surfactants, optionally a wax emulsion, optionally a coagulant and one or more additional optional additives to form aggregates, optionally forming a shell on the aggregated core particles, subsequently optionally coalescing or fusing the aggregates, and then recovering, optionally washing and optionally drying the obtained emulsion aggregation toner particles.

An example emulsion/aggregation/coalescing process preferably includes forming a mixture of latex binder, colorant dispersion, optional wax emulsion, optional coagulant and deionized water in a vessel. The mixture is then stirred using a homogenizer until homogenized and then transferred to a reactor where the homogenized mixture is heated to a temperature of, for example, at least about 50° C. and held at such temperature for a period of time to permit aggregation of toner particles to a desired size. Additional latex binder may then be added to form a shell upon the aggregated core particles. Once the desired size of aggregated toner particles is achieved, the pH of the mixture is adjusted in order to inhibit further toner aggregation. The toner particles are further heated to a temperature of, for example, at least about 90° C., and the pH lowered in order to enable the particles to coalesce and spherodize. The heater is then turned off and the reactor mixture allowed to cool to room temperature, at which point the aggregated and coalesced toner particles are recovered and optionally washed and dried.

Most preferably, following coalescence and aggregation, the particles are wet sieved through an orifice of a desired size in order to remove particles of too large a size, washed and treated to a desired pH, and then dried to a moisture content of, for example, less than 1% by weight.

The toner particles are preferably blended with external additives following formation. Any suitable surface additives may be used. Preferred external additives include one or more of SiO₂, metal oxides such as, for example, TiO₂ and aluminum oxide, and a lubricating agent such as, for example, a metal salt of a fatty acid (e.g., zinc stearate (ZnSt), calcium stearate) or long chain alcohols such as UNILIN 700. In general, silica is applied to the toner surface for toner flow, tribo enhancement, admix control, improved development and transfer stability and higher toner blocking temperature. TiO₂ is applied for improved relative humidity (RH) stability, tribo control and improved development and transfer stability. Zinc stearate is preferably also used as an external additive for the toners of the invention, the zinc stearate providing lubricating properties. Zinc stearate provides developer conductivity and tribo enhancement, both due to its lubricating nature. In addition, zinc stearate enables higher toner charge and charge stability by increasing the number of contacts between toner and carrier particles. Calcium stearate and magnesium stearate provide similar functions. Most preferred is a commercially available zinc stearate known as Zinc Stearate L, obtained from Ferro Corporation. The external surface additives can be used with or without a coating.

Most preferably, the toners contain from, for example, about 0.5 to about 5 weight percent titania (size of from about 10 nm to about 50 nm, preferably about 40 nm), about 0.5 to about 5 weight percent silica (size of from about 10 nm to about 50 nm, preferably about 40 nm), about 0.5 to about 5 weight percent sol-gel silica and about 0.1 to about 4 weight percent zinc stearate.

The toner particles can optionally be formulated into a developer composition by mixing the toner particles with carrier particles. Illustrative examples of carrier particles that can be selected for mixing with the toner composition include those particles that are capable of triboelectrically obtaining a charge of opposite polarity to that of the toner particles. Accordingly, in one embodiment, the carrier particles may be selected so as to be of a positive polarity in order that the toner particles that are negatively charged will adhere to and surround the carrier particles. Illustrative examples of such carrier particles include granular zircon, granular silicon, glass, steel, nickel, iron ferrites, silicon dioxide, and the like. Additionally, there can be selected as carrier particles nickel berry carriers as disclosed in U.S. Pat. No. 3,847,604, the entire disclosure of which is totally incorporated herein by reference, comprised of nodular carrier beads of nickel, characterized by surfaces of reoccurring recesses and protrusions thereby providing particles with a relatively large external area. Other carriers are disclosed in U.S. Pat. Nos. 4,937,166 and 4,935,326, the disclosures of which are totally incorporated herein by reference.

The selected carrier particles can be used with or without a coating, the coating generally being comprised of fluoropolymers, such as polyvinylidene fluoride resins, terpolymers of styrene, methyl methacrylate, and a silane, such as triethoxy silane, tetrafluoroethylenes, other known coatings and the like.

A preferred carrier herein is a steel core, for example of about 50 to about 75 μm in size, coated with about 0.5% to about 5% by weight, preferably about 1% by weight, of a conductive polymer mixture comprised of methylacrylate and carbon black using the process described in U.S. Pat. No. 5,236,629 and U.S. Pat. No. 5,330,874.

The carrier particles can be mixed with the toner particles in various suitable combinations. The concentrations are usually about 1% to about 20% by weight of toner and about 80% to about 99% by weight of carrier. However, one skilled in the art will recognize that different toner and carrier percentages may be used to achieve a developer composition with desired characteristics.

The aforementioned toner particles in a developer composition deliver a transfer efficiency of about 0.8-1.0, a developed mass per unit area of about 0.3 to about 1.5 mg/cm², and a mean charge to diameter ratio (q/d) of about −0.7 to about −0.1 femtocoulomb per micron. While any known methods may be used for measuring the above-identified properties, preferred methods are as follows. Transferred mass per unit area (TMA) is measured as a function of DC voltage between the donor roll and magnetic roll (Vdev) at a constant AC voltage (Vjump) of 2,225 volts. TMA is measured by blowing the toner off an unfused solid area image of a known area and weighing the paper. Transfer efficiency is measured at the electrostatic conditions for nominal TMA of 0.55 mg/cm² as a ratio of transferred to developed mass per unit area (TMA/DMA). Developed mass per unit area (DMA) is measured by collecting developed toner off a solid area image on a photoreceptor on a Millipore filter with a vacuum pump, and weighing the filter. Sump toner concentration and Q/M are measured by using a toner blow-off cage. Q/d is estimated in a charge spectrograph by visual measurements of the low and high limits of toner deflection from the zero-field dot position.

The toners can be used in known electrostatographic imaging methods. Thus for example, the toners or developers can be charged, e.g., triboelectrically, and applied to an oppositely charged latent image on an imaging member such as a photoreceptor or ionographic receiver. The resultant toner image can then be transferred, either directly or via an intermediate transport member, to an image receiving substrate such as paper or a transparency sheet. The toner image can then be fused to the image receiving substrate by application of heat and/or pressure, for example with a heated fuser roll.

In a most preferred embodiment, the toners are ideally suited for use in a device utilizing hybrid jumping development. Such development involves at least two steps. First, a two component (toner and carrier) composition is used to develop toner onto a biased donor member, such as a donor roll. Subsequently, single component (toner alone) gap development is effected, the toner jumping from the donor roll onto the image on the photoreceptor surface. The charging control conditions for such development systems are known in the art, and need not be further described herein.

The single component stage of development in this development method is sensitive to toner size and shape. Non-optimum particle morphology can lead to accumulation of toner particles on the donor roll, which can lead to the formation of an insulative layer on the donor roll and subsequent reduction in developability. The toners described herein substantially avoid such problems with their ideal size and shape.

The toner and developer will now be further described via the following examples.

### Examples 1-4

Four toner particles (Examples 1-4) were made by the following method.

A styrene/butyl acrylate polymer latex (latex 1) was prepared by semi-continuous emulsion polymerization with a 77.5/22.5 composition ratio (by weight). The polymer also contained 0.35 pph of crosslinking agent (decanedioldiacrylate) and was acid functionalized by the inclusion of 3.0 pph β-carboxyethyl acrylate (β-CEA). The molecular weight was controlled by the addition of 1.57 pph dodecanethiol; 0.4 pph was added during the first half of the monomer feed and the remaining 1.17 pph was added in the second half of the monomer feed. The monomer was fed to the reactor as an oil-in-water emulsion prepared with DOWFAX anionic surfactant. The reaction was conducted at 75° C. and the monomer was fed in over 200 minutes. The initiator used was ammonium persulfate at 1.5 pph. Latex 1 has a Mw of 35,400, an Mn of 11,800, an onset glass transition temperature (Tg) of 51° C., a particle size of 210 nm and 40% solids.

A second styrene/butyl acrylate latex (latex 2) was prepared by semi-continuous emulsion polymerization with a 65/35 composition ratio (by weight). The polymer also contained 1.0 pph of crosslinking agent (divinyl benzene) and was acid functionalized by the inclusion of 3.0 pph β-CEA. The monomer was fed to the reactor as an oil-in-water emulsion prepared with NEOGEN RK anionic surfactant. The reaction was conducted at 75° C. and the monomer was fed in over 100 minutes. The initiator used was ammonium persulfate at 1.7 pph. Latex 2 has an onset glass Tg of 43° C., a particle size of 48 nm and 20% solids. The latex had extensive gelation, and thus molecular weight properties could not be reliably determined.

The prepared latexes were mixed with a carbon black pigment dispersion and a wax dispersion, and then flocculated with polyaluminum chloride and calcium chloride at room temperature. The slurry was homogenized and then heated with mixing to control particle growth. Once the appropriate size of flocculated particles had been achieved, as measured on a Beckman Coulter counter, a second lot of latex 1 was added to form a shell layer. Once the desired final size was achieved, e.g., 5.0 to 6.7 μm, the particle growth is stopped by the addition of base to adjust the pH to 7. The slurry was then heated to 95° C. and the particles were allowed to coalesce at the appropriate pH until the desired particle shape was achieved, circularity being determined by Malvern Sysmex Flow Particle Image Analyzer FPIA-2100).

Each of the four toner particles contained (by weight):
core resin (latex 1)—43%;
shell resin (latex 1)—28%;
core gel resin (latex 2)—10%;
carbon black pigment (Cabot REGAL 330)—10%;
polyethylene wax (Baker Petrolite POLYWAX 850)—9%;
calcium chloride—150 ppm; and
poly aluminum chloride—0.17 pph.

The following Table summarizes the properties of each of the four toners.

| | Example | | | |
|---|---|---|---|---|
| | 1 | 2 | 3 | 4 |
| Description | Smaller, more | Larger, more | Larger, less | Smaller, less |
| | spherical | spherical | spherical | spherical |
| Coalescence | 5 hrs @ 95° C., | 5 hrs @ 95° C., | 5 hrs @ 95° C., | 5 hrs @ 95° C., |
| conditions | pH 3.6 | pH 3.6 | pH 3.8 | pH 4.0 |
| D50 | 5.49 | 6.68 | 6.64 | 5.66 |
| GSDv | 1.19 | 1.21 | 1.20 | 1.20 |
| GSDn lower | 1.26 | 1.26 | 1.29 | 1.27 |
| % pop fines | 19.1 | 7.6 | 8.3 | 14.1 |
| (1.3-4.0 μm) | | | | |
| Circularity | 0.963 | 0.962 | 0.952 | 0.955 |

The same additive package was applied to each of the four toners: additive package comprising 2% 40 nm silica, 1.8% 40 nm titanium oxide, 1.7% sol-gel silica, 0.5% zinc stearate, and each of the four toners was then combined with the same amount of steel core carrier powder coated with 1% by weight of a conductive polymer mixture comprised of poly(methyl-methacrylate) and carbon black using process described in U.S. Pat. No. 5,236,629. A Xerox hybrid jumping development printer DC265 was used for developability and transfer efficiency testing at t=0 and after zero-throughput aging by printing 1,000 blank pages with no throughput. The developers were conditioned overnight in (1) 15% relative humidity (RH) and (2) 85% RH followed by 5-minute charging in a paint shaker. Transferred mass per unit area (TMA) was measured as a function of DC voltage between the donor roll and magnetic roll (Vdev) at a constant AC voltage (Vjump) of 2,225 volts. TMA was measured by blowing the toner off an unfused solid area image. Transfer efficiency was measured at the electrostatic conditions for nominal TMA of 0.55 mg/cm² as a ratio of transferred to developed mass per unit area (TMA/DMA). Developed mass per unit area (DMA) was measured by collecting developed toner off a solid area image on a photoreceptor on a Millipore filter with a vacuum pump. Toner concentration and Q/M in the developer tank are measured by using a toner blow-off cage. Q/d was estimated in a charge spectrograph by visual measurements of the low and high limits of toner deflection from the zero-field dot position.

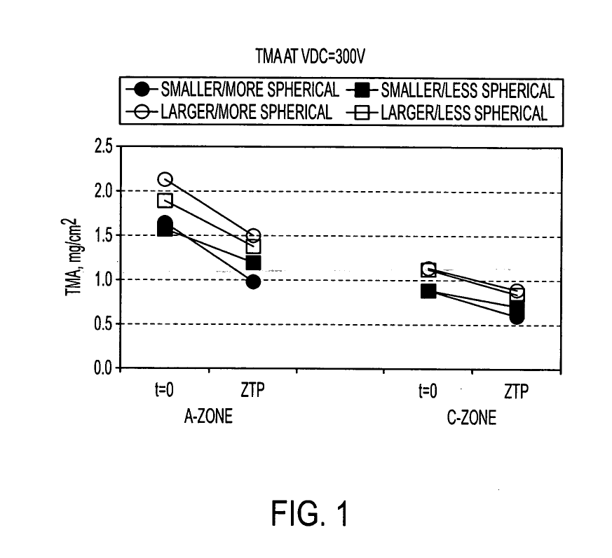

FIG. 1 summarizes the developability for each of the four toners. Developability was evaluated by measuring TMA at t=0 and after aging the developer by printing 1,000 blank copies under controlled environmental conditions at 85% relative humidity (RH) and 15% RH at a nominal development voltage of 300 v. Developability generally decreases from higher to lower relative humidity and from fresh to aged developer. Also, developability generally increases with an increase in size and, at a larger size, developability increases further with more spherical shape.

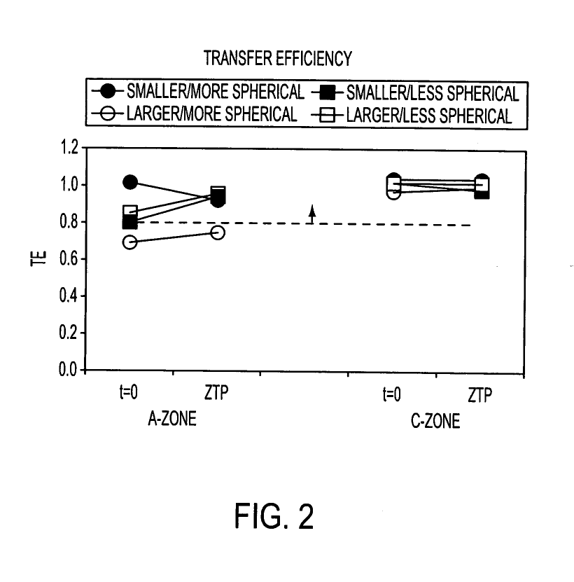

FIG. 2 summarizes the transfer efficiency for each of the four toners. In 15% RH, transfer efficiency is almost independent of size or shape. In 85% RH, transfer efficiency significantly increases with a decrease in particle size. For smaller particle size, transfer efficiency increases as the particle becomes more spherical.

The foregoing results indicate that for hybrid jumping development, the desirable minimum transfer efficiency of 0.9 is best met by the smaller, more spherical particles of Example 1. Thus, in a most preferred embodiment, the toner particles preferably have a size of from about 5.40 to about 5.55 μm and a circularity of about 0.960 to about 0.965.

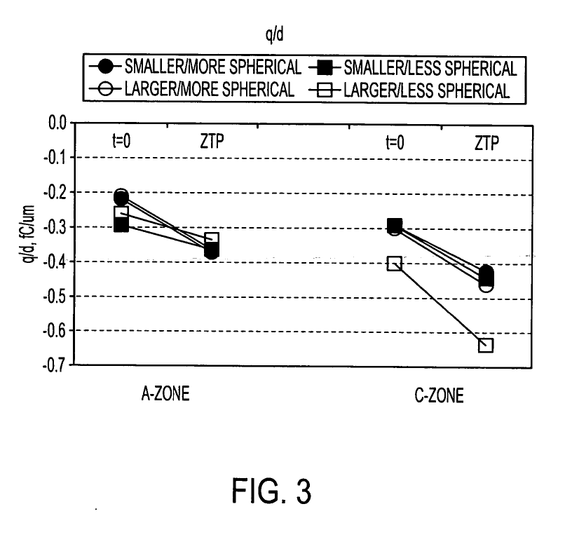

FIG. 3 summarizes the charge (q/d) for each of the four toners. FIG. 3 indicates that q/d almost does not depend on particle size or shape, excluding the larger, less-spherical particles in 15% RH. It appears clear from the results that charge plays a relatively insignificant role. That is, 15% RH q/d appears independent of size and shape.

The results indicate that generally, toner developability and stability deteriorates with decrease in particle size and increase in circularity, while transfer efficiency increases with decrease in particle size and increase in circularity.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A toner comprising emulsion aggregation toner particles comprising a binder, comprised of an acrylate-containing polymer, and at least one colorant, wherein the toner particles have an average particle size of from about 5.0 μm to about 6.7 μm and an average circularity of about 0.950 to about 0.970, and wherein the toner particles exhibit a transfer efficiency of about 0.8-1.0, a developability of about 0.3 to about 1.5 mg/cm², and a charge to diameter ratio (q/d) of about −0.7 to about −0.1 femto-Coulombs per micron.

2. The toner according to claim 1, wherein the acrylate-containing polymer is a styrene-alkyl acrylate.

3. The toner according to claim 2, wherein the styrene-alkyl acrylate polymer is a styrene-butyl acrylate.

4. The toner according to claim 1, wherein the binder further comprises an acrylate-containing gel.

5. The toner according to claim 4, wherein the acrylate-containing gel comprises from about 8% to about 35% by weight of the total binder.

6. The toner according to claim 1, wherein the toner particles further include a shell layer thereon.

7. The toner according to claim 6, wherein the shell layer consists essentially of an acrylate-containing polymer.

8. The toner according to claim 7, wherein the acrylate-containing polymer of the shell layer and the acrylate-containing polymer of the binder are the same.

9. The toner according to claim 1, wherein the toner particles further comprise a wax dispersion.

10. The toner according to claim 1, wherein the toner particles have an average particle size of from about 5.40 to about 5.55 μm and an average circularity of about 0.960 to about 0.965.

11. The toner according to claim 1, wherein the toner particles further comprise one or more external additives selected from the group consisting of silica, sol-gel silica, titanium dioxide and zinc stearate.

12. The toner according to claim 1, wherein the toner particles include an external additive package comprised of about 0.5 to about 5 weight percent titania having a size of from about 10 nm to about 50 nm, about 0.5 to about 5 weight percent silica having a size of from about 10 nm to about 50 nm, about 0.5 to about 5 weight percent sol-gel silica and about 0.1 to about 4 weight percent zinc stearate.

13. A developer comprising
a toner comprising emulsion aggregation toner particles comprising a binder, comprised of an acrylate-containing polymer, and at least one colorant, wherein the toner particles have an average particle size of from about 5.0 μm to about 6.7 μm and an average circularity of about 0.950 to about 0.970, and wherein the toner particles exhibit a transfer efficiency of about 0.8-1.0, a developability of about 0.3 to about 1.5 mg/cm², and a charge to diameter ratio (q/d) of about −0.7 to about −0.1 femto-Coulombs per micron, and
carrier particles.

14. The developer according to claim 13, wherein the carrier particles comprise a steel core having a size of from about 50 μm to about 75 μm.

15. The developer according to claim 14, wherein the steel core carrier particles are coated with about 0.5% to about 5% by weight of a poly(methyl-methacrylate) polymer containing about 10 to about 20 weight % carbon black.

16. The developer according to claim 13, wherein the carrier particles comprise from about 80% to about 99% by weight, and the toner comprises from about 1% to about 20% by weight, of the developer.

17. A method of forming an image with toner, comprising charging the toner, applying the charged toner to an oppositely charged latent image on an imaging member to develop the image, and transferring the developed image to an image receiving substrate, wherein the toner comprises emulsion aggregation toner particles comprising a binder, comprised of an acrylate-containing polymer, and at least one colorant, wherein the toner particles have an average particle size of from about 5.0 μm to about 6.7 μm and an average circularity of about 0.950 to about 0.970, and
wherein the applying of charged toner is effected via hybrid jumping development wherein the toner is first supplied to a biased donor member and then the toner is made to jump to the imagining member from the biased donor member.

18. The method according to claim 17, wherein the toner particles exhibit a transfer efficiency of about 0.8-1.0, a developability of about 0.3 to about 1.5 mg/cm², and a charge to diameter ratio (q/d) of about −0.7 to about −0.1 femto-Coulombs per micron.

19. The method according to claim 17, wherein the toner is in admixture with carrier particles.

20. The method according to claim 17, wherein the biased donor member is a dinner roll.

21. An image forming device for providing an image on an image receiving substrate by the method according to claim 17.
